(19) United States
(12) Patent Application Publication
(10) Pub. No.: US 2023/0335753 A1
(43) Pub. Date: Oct. 19, 2023

(54) PATTERNED CURRENT COLLECTOR FOR ANODELESS ELECTROCHEMICAL BATTERY CELLS

(71) Applicant: GM GLOBAL TECHNOLOGY OPERATIONS LLC, Detroit, MI (US)

(72) Inventors: Meng JIANG, Rochester Hills, MI (US); Jiazhi HU, Troy, MI (US); Biqiong WANG, Madison Heights, MI (US); Meinan HE, Birmingham, MI (US); Fan XU, Oakland Township, MI (US); Michael P. BALOGH, Novi, MI (US)

(73) Assignee: GM GLOBAL TECHNOLOGY OPERATIONS LLC, Detroit, MI (US)

(21) Appl. No.: 17/720,919

(22) Filed: Apr. 14, 2022

(51) Int. Cl. H01M 4/72; H01M 4/134

(52) U.S. Cl. CPC H01M 4/72; H01M 4/134

(57) ABSTRACT

An anodeless electrochemical cell is provided that includes a positive electroactive material layer and a patterned current collector. The patterned current collector includes a non-conductive substrate and a conductive network disposed over a surface of the non-conductive substrate. The surface of the non-conductive substrate defines a first surface area, and a perimeter of the conductive network defines a second surface area. The second surface area covers greater than 90% of the first surface area. The conductive network includes a framework having plurality of pores, such that the conductive network has a porosity greater than or equal to about 20 vol. % to less than or equal to about 95 vol. %. During a charging event, the pores are configured to receive deposited lithium metal. The anodeless electrochemical cell further includes a separator between the positive electroactive material layer and the patterned current collector.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Batteries are configured to reversibly supply power to an associated load device. For example, electrical power can be supplied to a load device by a battery until the active lithium content of the negative electrode (i.e., anode) is effectively depleted or the capacity limit of the positive electrode (i.e., cathode) is reached. The battery can then be recharged by passing a suitable direct electrical current in the opposite direction between the electrodes. More particularly, during discharge, the negative electrode includes deposited or plated lithium that can be oxidized into lithium ions and electrons. The lithium ions can travel from the negative electrode to the positive electrode, through the (ionically conductive) electrolyte solution contained, for example, within the pores of an interposed separator. Once there, the lithium ions can be inserted into the positive electroactive material by electrochemical reduction reactions. As the lithium ions travel from the negative electrode to the positive electrode, the electrons can pass through an external circuit from the negative electrode to the positive electrode.

In comparison, during recharge, transition metal ions in the positive electrode can be oxidized, and the lithium ions can travel from the positive electrode to the negative electrode, for example, through the separator via the (ionically conductive) electrolyte, and the electrons pass through the external circuit to the negative electrode. Once there, the lithium ions can be reduced to elemental lithium in the negative electrode and stored for future use. The battery may be recharged after any partial or full discharge of its available capacity by an external power source. As noted, recharging can reverse electrochemical reactions that transpired during discharge.

During various discharge and recharge processes, undesirable metal plating and dendrite formation often occurs at the negative electrode, for example, as a result of the degradation of the active materials, creating unusable or dead lithium. The metal dendrites extending from a surface of the negative electrode may form protrusions that potentially puncture the separator and cause, for example, an internal short circuit, which can cause low Coulombic efficiencies, poor cycle performances, and potential safety issues. Accordingly, it would be desirable to develop materials for use in high energy lithium-ion batteries that reduce metal dendrite formation and similarly suppress or minimize its effects.

### SUMMARY

This section provides a general summary of the disclosure, and is not a comprehensive disclosure of its full scope or all of its features.

The present disclosure relates to anodeless electrochemical battery cells, and more particularly, to patterned current collector for use in anodeless electrochemical battery cells, and methods of making and using the same.

In various aspects, the present disclosure provides a patterned current collector for use as a negative electrode current collector in an anodeless electrochemical cell that cycles lithium ions. The patterned current collector may include a non-conductive substrate and a conductive network disposed on or adjacent to a surface of the non-conductive substrate. The conductive network may have a porosity greater than or equal to about 20 vol. % to less than or equal to about 95 vol. %.

In one aspect, the surface of the non-conductive substrate may define a first surface area, and an outer perimeter of the conductive network defines a second surface area. The second surface area may cover greater than or equal to about or exactly 90% to less than or equal to exactly 100% of the first surface area.

In one aspect, the conductive network may be a homogeneously dimensioned grid.

In one aspect, the conductive network may include two or more overlapping layers.

In one aspect, the patterned current collector may further include an insulating layer disposed over the conductive network.

In one aspect, the insulating layer may have a thickness greater than or equal to about 0.5 μm to less than or equal to about 2 μm.

In one aspect, the non-conductive substrate may have a thickness greater than or equal to about 1 μm to less than or equal to about 50 μm.

In one aspect, the conductive network may have a thickness greater than or equal to about 1 μm to less than or equal to about 100 μm.

In one aspect, the conductive network may be printed on the non-conductive substrate.

In one aspect, a conductive film may be an etched conductive film disposed over the non-conductive substrate.

In various aspects, the present disclosure provides an anodeless electrochemical cell that cycles lithium ions. The anodeless electrochemical cell may include a lithium-containing positive electroactive material layer disposed on a first current collector and a second current collector. The second current collector may be a patterned current collector that includes a non-conductive substrate and a conductive network disposed on or near a surface of the non-conductive substrate. The conductive network may have a porosity greater than or equal to about 20 vol. % to less than or equal to about 95 vol. %. The anodeless electrochemical cell may further include a separator disposed between the positive electroactive material layer and the second current collector.

In one aspect, the surface of the non-conductive substrate mat define a first surface area, and an outer perimeter of the conductive network may define a second surface area. The second surface area may cover greater than or equal to about or exactly 90% to less than or equal to exactly 100% of the first surface area.

In one aspect, the conductive network may be a homogeneously dimensioned grid.

In one aspect, the conductive network may include two or more overlapping layers.

In one aspect, the patterned current collector may further include an insulating layer disposed on the conductive network.

In one aspect, the insulating layer may have a thickness greater than or equal to about 0.5 μm to less than or equal to about 2 μm.

In one aspect, the non-conductive substrate may have a thickness greater than or equal to about 1 μm to less than or equal to about 50 μm.

In one aspect, the conductive network may have a thickness greater than or equal to about 1 μm to less than or equal to about 100 μm.

In one aspect, a composition of the non-conductive substrate may be the same as a composition of the separator.

In various aspects, the present disclosure provides an anodeless electrochemical cell that cycles lithium ions. The anodeless electrochemical cell may include a lithium-containing positive electroactive material layer disposed on a first current collector and a second current collector. The lithium-containing positive electroactive material layer may have a thickness greater than or equal to about 1 μm to less than or equal to about 500 μm. The second current collector may be a patterned current collector that includes a non-conductive substrate and a conductive network disposed on or near a surface of the non-conductive substrate. The surface of the non-conductive substrate may define a first surface area, and a perimeter of the conductive network may define a second surface area. The second surface area may cover greater than or equal to about or exactly 90% to less than or equal to exactly 100% of the first surface area. The conductive network may include a framework and a plurality of pores defined in the framework, such that the conductive network has a porosity greater than or equal to about 20 vol. % to less than or equal to about 95 vol. %. During a charging event, the pores of the conductive network are configured to receive deposited lithium metal. The anodeless electrochemical cell may further include a separator having the same composition as the non-conductive substrate disposed between the positive electroactive material layer and the second patterned current collector.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic illustration of an example anodeless electrochemical battery cell having a patterned current collector in accordance with various aspects of the present disclosure;

FIG. 2 is a schematic illustration of an example patterned current collector in accordance with various aspects of the present disclosure;

FIG. 3A is a schematic illustration of an example patterned current collector after a first cell cycle;

FIG. 3B is a schematic illustration of an example patterned current collector after several cell cycles;

FIG. 4 is a schematic illustration of another example patterned current collector in accordance with various aspects of the present disclosure;

FIG. 5 is a schematic illustration of yet another example patterned current collector in accordance with various aspects of the present disclosure;

FIG. 6 is a schematic illustration of an example method for forming a patterned current collector in accordance with various aspects of the present disclosure;

FIG. 7 is a schematic illustration of an example method for forming a patterned current collector having an insulating layer in accordance with various aspects of the present disclosure;

FIG. 8 is a schematic illustration of another example method for forming a patterned current collector having an insulating layer in accordance with various aspects of the present disclosure; and

FIG. 9 is a schematic illustration of an example roll-to-roll method for forming an anodeless electrochemical battery including patterned current collectors in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure relates to anodeless electrochemical battery cells, and more particularly, to patterned current collector for use in anodeless electrochemical battery cells, and methods of making and using the same. A typical anodeless electrochemical cell includes a positive electrode (or cathode) assembly, which includes an electroactive material layer (also referred to as a positive electrode or cathode) and a first (or positive electrode) current collector parallel with the electroactive material layer, opposing a second (or negative electrode) current collector, where a separator and/or electrode is disposed between the positive electrode and the negative electrode current collector. Often, in a lithium-ion battery pack, the anodeless electrochemical batteries or cells may be electrically connected in a stack or winding configuration to increase overall output, and the battery operates by reversibly passing lithium ions between the positive electrode and the negative electrode current collector. For example, lithium ions may move from the positive electrode to the negative electrode current collector during a charging event, and in the opposite direct when discharging the battery. The electrolyte is suitable for conducting the lithium ions and may be in liquid, gel, or solid form. During discharge a portion of the lithium ions may remain with the negative electrode current collector, for example, as a result of solid electrolyte interphase (SEI) formation, where lithium ions are trapped and unusable often leading to capacity degradation.

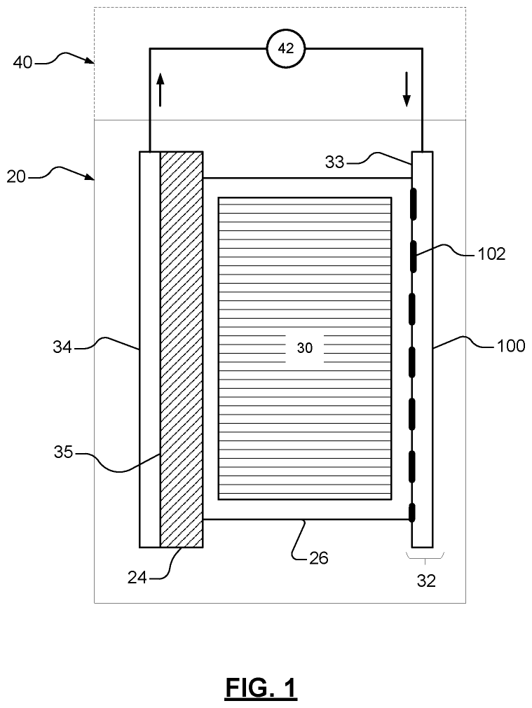

An exemplary and schematic illustration of an example anodeless electrochemical cell or battery 20 is shown in FIG. 1. The battery 20 as illustrated (and also, battery pack(s) including one or more of the cells 20) can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated battery 20 includes a single positive electrode (i.e., cathode) 24 and a single negative electrode current collector 32, the skilled artisan will recognize that the present teachings extend to various other configurations, including those having one or more positive electrodes and/or one or more negative electrode current collectors.

The battery 20 includes a first current collector 32 (e.g., a negative electrode current collector) and a second current collector 34 (e.g., a positive current collector). A positive electrode 24 is positioned at or near a first surface 35 of the positive electrode current collector 34, and a separator 26 is disposed between the positive electrode 24 and the negative electrode current collector 32. The separator 26 provides electrical separation—prevents physical contact—between the positive electrode 24 and the negative electrode current collector 32. The separator 26 also provides a minimal resistance path for internal passage of lithium ions, and in certain instances, related anions, during cycling of the lithium ions. In various aspects, the separator 26 includes an electrolyte 30 that may, in certain aspects, also be present in the positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 may include a plurality of solid-state electrolyte particles (not shown). The plurality of solid-state electrolyte particles included in, or defining, the separator 26 may be the same as or different from the plurality of solid-state electrolyte particles included in the positive electrode 24.

The first current collector 32 and the second current collector 34 may respectively collect and move free electrons to and from an external circuit 40. For example, an interruptible external circuit 40 and a load device 42 may connect the negative electrode current collector 32 and the positive electrode 24 (through the positive electrode current collector 34). The battery 20 can generate an electric current during discharge by way of reversible electrochemical reactions that occur when the external circuit 40 is closed (to connect the negative electrode current collector 32 and the positive electrode 24 (through the positive electrode current collector 34) and the negative electrode current collector 32 has a lower potential than the positive electrode. The chemical potential difference between the positive electrode 24 and the negative electrode current collector 32 drives electrons produced by a reaction, for example, the oxidation of deposited or plated lithium metal, at the negative electrode current collector 32 through the external circuit 40 toward the positive electrode 24. Lithium ions that are also produced at the negative electrode current collector 32 are concurrently transferred through the electrolyte 30 contained in the separator 26 toward the positive electrode 24. The electrons flow through the external circuit 40 and the lithium ions migrate across the separator 26 containing the electrolyte 30 to form inserted lithium at the positive electrode 24. The electric current passing through the external circuit 40 can be harnessed and directed through the load device 42 until the lithium in the negative electrode current collector 32 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation at the positive electrode 24 so that electrons and lithium ions are produced. The lithium ions flow back toward the negative electrode current collector 32 through the electrolyte 30 across the separator 26 to replenish the negative electrode current collector 32 with lithium metal for use during the next battery discharge event. As such, a complete discharging event followed by a complete charging event is considered to be a cycle, where lithium ions are cycled between the positive electrode 24 and the negative electrode current collector 32. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

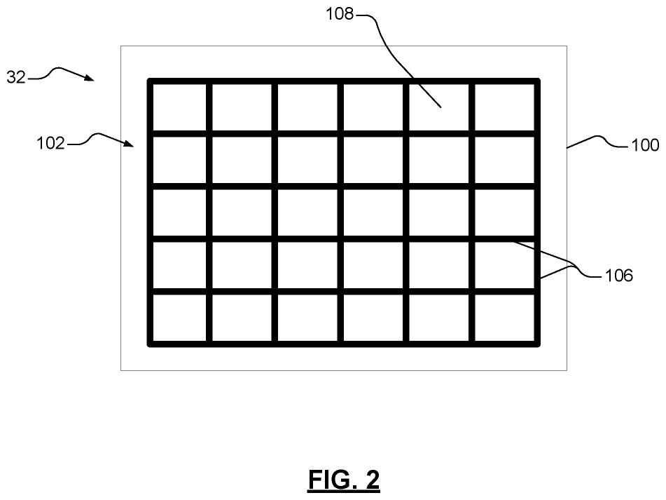

The positive electrode current collector 34 may be a metal foil, metal grid or screen, or expanded metal comprising aluminum or any other appropriate electrically conductive material known to those of skill in the art. In various aspects, the negative electrode current collector 32 is a patterned current collector. For example, as illustrated in FIG. 2, the negative electrode current collector 32 may include a non-conductive substrate or support 100 and a conductive network 102 disposed on or adjacent to one or more surfaces of the non-conductive substrate 100. As illustrated, the conductive network 102 may be disposed on or adjacent to a first surface 33 of the non-conductive substrate 100, where the first surface 33 of the non-conductive substrate 100 opposes the first surface 35 of the positive electrode current collector 34.

The non-conductive substrate 100 may be prepared in a manner similarly to the separator 26. In certain variations, the non-conductive substrate 100 may be the same as the separator 26. In each instance, the non-conductive substrate 100 may have a thickness greater than or equal to about or exactly 1 μm to less than or equal to about or exactly 50 μm. The conductive network 102 may be formed from carbon, copper, or any other appropriate electrically conductive material known to those of skill in the art. The conductive network 102 may have a thickness greater than or equal to about or exactly 1 μm to less than or equal to about or exactly 100 μm.

The conductive network 102 may take a variety of configurations. For example, as illustrated in FIG. 2, the conductive network 102 may form a grid having a framework 106 of spaced boundaries (or bars or edges) and a plurality of openings (or spaces, or pores) 108 therebetween. In certain variations, the spaced boundaries (or bars or edges) forming the framework 106 are homogenous in each unit area, in other words, a homogeneously dimensioned grid or mesh. Although not illustrated, the skilled artisan will recognize that, in other variations, the conductive network 102 may have other configurations, including regular and irregular configurations, each having, however, a plurality of openings (or spaces, or pores). For example, in certain instances, the conductive network 102 may be in the form of a hexagonal grid or triangular grid. In each variation, an outer perimeter or boundary of the conductive network 102 will be understood to define a (first) surface area that is substantially coextensive with a (second) surface area of the underlying substrate 100. For example, the surface area of the conductive network 103 may cover greater than or equal to about or exactly 90% to less than or equal to exactly 100% of a total surface area of the non-conductive substrate 100. The conductive network 102 may have a porosity greater than or equal to about or exactly 20 vol. % to less than or equal to about or exactly 95 vol. %. The porosity can be optimized based on areal loading of the positive electrode 24 and application of the battery 20 (e.g., high energy versus high power).

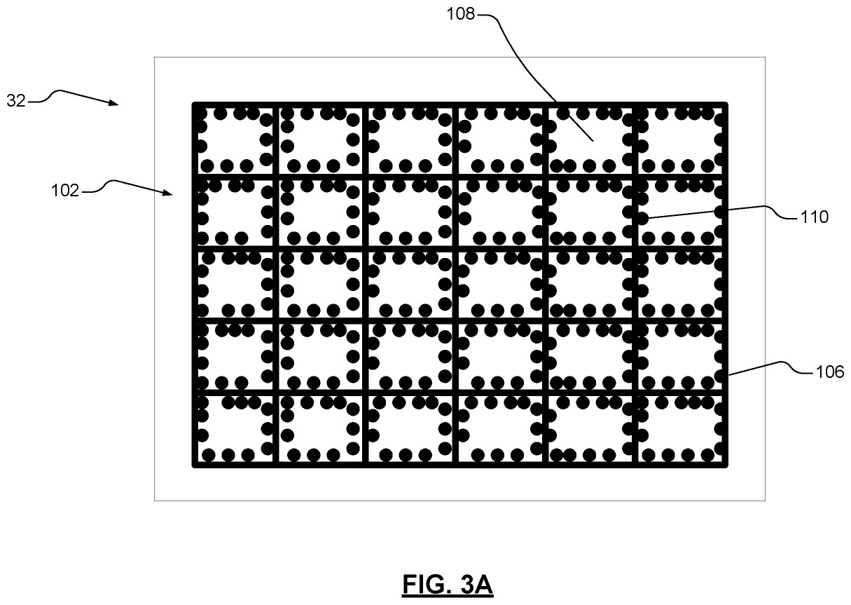

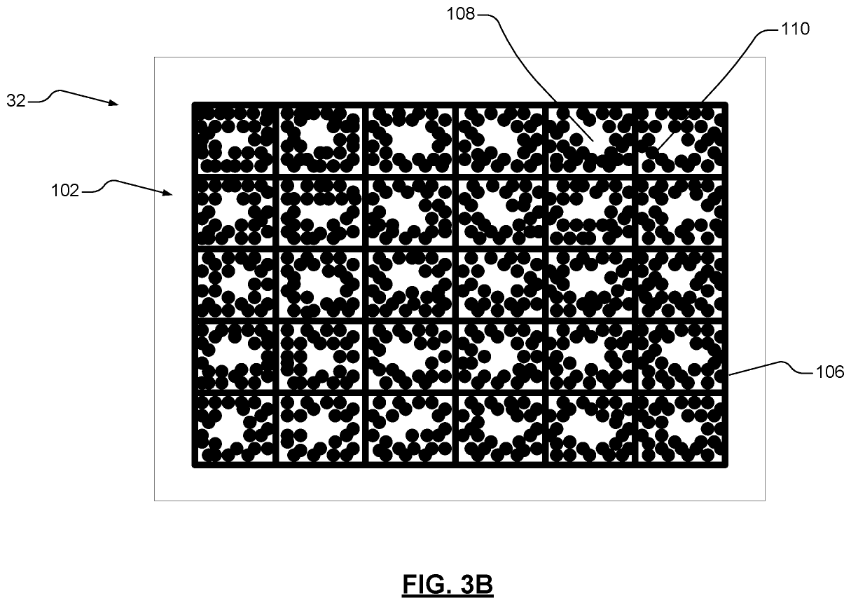

As illustrated in FIGS. 3A and 3B, lithium ions 110 arriving at the negative electrode current collector 32 (for example, from the positive electrode 24) are deposited within the openings 108 of the conductive network 102. More specifically, the lithium metal 110 grows towards the center of each the opening 108 (i.e., in-plane growth). For example, FIG. 3A illustrates the negative electrode current collector 32 after a first cell cycle, and FIG. 3B illustrates the negative electrode current collector 32 after several cell cycles. The concentric growth of the lithium metal, as illustrated, eliminates, or minimizes, dendrite growth towards the separator 26.

With renewed reference to FIG. 1, in many lithium-ion battery configurations, each of the first current collector 32, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode current collector 32, the separator 26, the positive electrode 24, and/or the positive electrode current collector 34. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24 and the separator 26 may each include an electrolyte solution or system 30 inside their pores, capable of conducting lithium ions between the negative electrode current collector 32 and the positive electrode 24. Any appropriate electrolyte 30, whether in solid, liquid, or gel form, capable of conducting lithium ions between the negative electrode current collector 32 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1,2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on or adjacent to one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about or exactly 1 μm to less than or equal to about or exactly 50 μm, and in certain instances, optionally greater than or equal to about or exactly 1 μm to less than or equal to about or exactly 20 μm.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode current collector 32. The solid-state electrolyte layer and/or semi-solid-state electrolyte layer facilitates transfer of lithium ions, while mechanically separating and providing electrical insulation between the negative electrode current collector 32 and positive electrode 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃xLa_{2/3-x}TiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof.

The positive electrode 24 may be formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. In certain variations, the positive electrode 24 may include a plurality of solid-state electrolyte particles (not shown). In each instance, the positive electrode 24 may have an average thickness greater than or equal to about or exactly 1 μm to less than or equal to about or exactly 500 μm, and in certain aspects, optionally greater than or equal to about or exactly 10 μm to less than or equal to about or exactly 200 μm.

One exemplary common class of known materials that can be used to form the positive electrode 24 is layered lithium transitional metal oxides. For example, in certain aspects, the positive electrode 24 may comprise one or more materials having a spinel structure, such as lithium manganese oxide (Li₍ᵢ₊ₓ₎Mn₂O₄, where 0.1≤x≤1) (LMO), lithium manganese nickel oxide (LiMn₍₂₋ₓ₎NiₓO₄, where 0≤x≤0.5) (LNMO) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co_{0.33}O₂) (NMC), or a lithium nickel cobalt metal oxide (LiNi_{(i-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄) (LFP), lithium manganese-iron phosphate (LiMn₂₋ₓFeₓPO₄, where 0<x<0.3) (LFMP), or lithium iron fluorophosphate (Li₂FePO₄F). In various aspects, the positive electrode 24 may comprise one or more electroactive materials selected from the group consisting of: NCM 111, NCM 532, NCM 622, NCM 811, NCMA, LFP, LMO, LFMP, LLC, and combinations thereof.

In certain variations, the positive electroactive material(s) in the positive electrode 24 may be optionally intermingled with an electronically conducting material that provides an electron conduction path and/or at least one polymeric binder material that improves the structural integrity of the electrode 24. For example, the positive electroactive material(s) in the positive electrode 24 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The positive electrode 24 may include greater than or equal to about or exactly 5 wt. % to less than or equal to about or exactly 99 wt. %, optionally greater than or equal to about or exactly 10 wt. % to less than or equal to about or exactly 99 wt. %, and in certain variations, greater than or equal to about or exactly 50 wt. % to less than or equal to about or exactly 98 wt. %, of the positive electroactive material(s); greater than or equal to about or exactly 0 wt. % to less than or equal to about or exactly 40 wt. %, and in certain aspects, optionally greater than or equal to about or exactly 1 wt. % to less than or equal to about or exactly 20 wt. %, of the electronically conducting material; and greater than or equal to about or exactly 0 wt. % to less than or equal to about or exactly 40 wt. %, and in certain aspects, optionally greater than or equal to about or exactly 1 wt. % to less than or equal to about or exactly 20 wt. %, of the at least one polymeric binder.

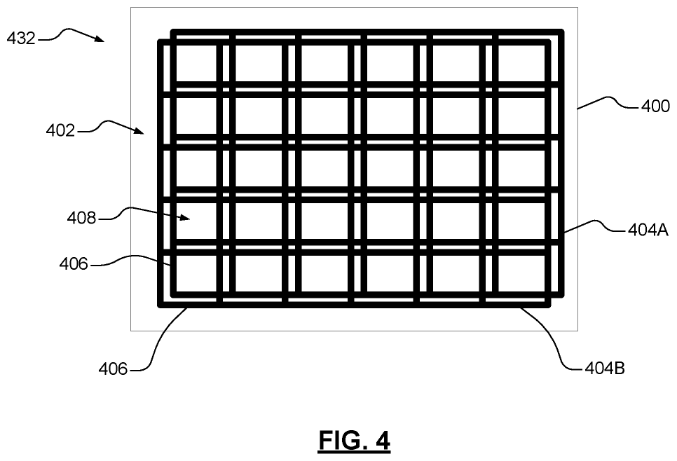

In various aspects, the current disclosure provides other patterned current collectors, for example, for use in an anodeless electrochemical cell, like the battery 20 illustrated in FIG. 1. For example, in certain variations, as illustrated in FIG. 4, a patterned current collector 432 may include, like the negative electrode current collector 32 illustrated in FIG. 2, a non-conductive substrate or support 400 and a conductive network 402 disposed on or adjacent to one or more surfaces of the non-conductive substrate 400. The conductive network 402, however, may include two or more overlapping layers 404A, 404B. In certain variations, the overlapping layers 404A, 404B may be aligned or stacked. In other variations, as illustrated, the overlapping layers 404A, 404B may be offset in the z-y direction. In further variations, one or more of the two or more overlapping layers 404A, 404B may be aligned or stacked, while one or more of the two or more overlapping layers 404A, 404B are offset in the z-y direction. In each instance, like the conductive network 102 illustrated in FIG. 2, the overlapping layers 404A, 404B may form a grid having a framework 406 of spaced boundaries (or bars or edges) and a plurality of openings (or spaces, or pores) 408 therebetween. Although not illustrated, the skilled artisan will appreciate that the respective layers of the two or more overlapping layers 404A, 404B may have various orientations. In each instance, the two or more overlapping layers 404A, 404B may more boundaries on which lithium metal may be deposited, and also, more pore volumes for in-plane growth of lithium metal during charge, thereby preventing or reducing out-of-plane growth and dendrite formation

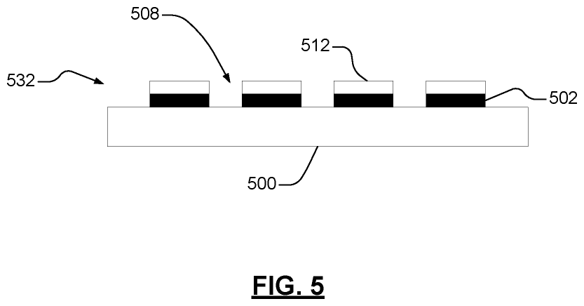

In other variations, as illustrated in FIG. 5, a patterned current collector 532 may include, like the negative electrode current collector 32 illustrated in FIG. 2 and/or the negative electrode current collector 432 illustrated in FIG. 4, a non-conductive substrate or support 500 and a conductive network 502 disposed on or adjacent to one or more surfaces of the non-conductive substrate 500. The patterned current collector 532, however, may further include an insulating layer 512. For example, as illustrated, an insulating layer 512 may be disposed on or adjacent to surfaces of the conductive network 502 away from the non-conductive substrate 500 (i.e., surfaces that would face a positive electrode). The insulating layer 112 may have a thickness greater than or equal to about or exactly 0.05 μm to less than or equal to about or exactly 2 μm. The insulating layer 112 may include one or more insulating materials may be a known oxide, polymer, salt, or the like. Insulating layers, like the insulating layer 512 illustrated in FIG. 4, may help to eliminate, or minimize, the deposition of lithium metal on surfaces of the conductive network 502, further encouraging concentric growth of the lithium metal within the openings 508 of the conductive network.

In various aspects, the present disclosure provides methods for forming patterned current collectors. For example, the present disclosure provides methods for forming patterned current collectors, like the patterned current collector 32 illustrated in FIG. 2. In certain variations, methods for forming patterned current collectors, like the patterned current collector 32 illustrated in FIG. 2, include contacting a non-conductive substrate with a conductive layer. The conductive layer formed from carbon, copper, or any other appropriate electrically conductive material known to those of skill in the art and having a porosity greater than or equal to about or exactly 20 vol. % to less than or equal to about or exactly 95 vol. %. The contacting may include applying a conductive adhesive onto a surface of the non-conductive substrate, followed by direct printing/deposition of a conductive material and/or patterned coating of the conductive material.

In other variations, methods for forming patterned current collectors, like the patterned current collector 32 illustrated in FIG. 2, include printing a conductive material on one or more surfaces of a non-conductive substrate to form a conductive layer. The printing may include aerosol jet/inkjet printing processes, physical vapor deposition processes, sputtering processes, photolithography processes, and the like. In certain variations, two or more conductive layers may be printed so as to form a conductive network having two or more overlapping layers, like the patterned current collector 432 illustrated in FIG. 4.

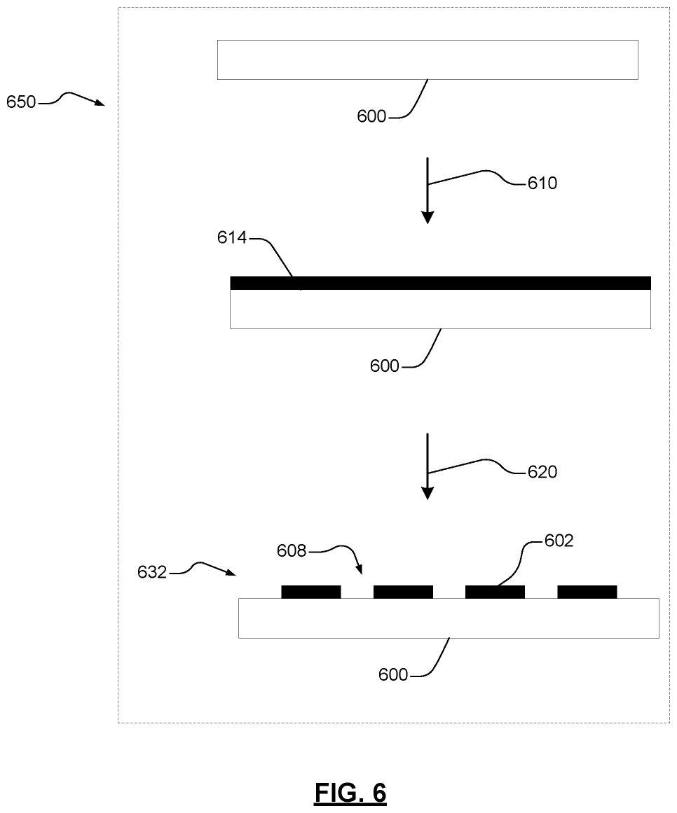

FIG. 6 illustrates yet another example method 650 for forming a patterned current collector 632, like the patterned current collector 32 illustrated in FIG. 2. The method 650 may include contacting 610 one or more surfaces of a non-conductive substrate 600 with a metal film 614. The contacting 610 may include disposing the metal film 614 on the one or more surfaces of the non-conductive substrate using, for example only, physical vapor deposition (PVD) processes, chemical vapor deposition (CVD) processes, sputtering processes, thermal evaporation processes, inkjet/aerosol jet printing, and the like. The metal film 614 may include carbon, copper, or any other appropriate electrically conductive material known to those of skill in the art. The metal film 614 may have a thickness greater than or equal to about or exactly 1 μm to less than or equal to about or exactly 100 μm, and in certain aspects, optionally greater than or equal to about or exactly 0.1 μm to less than or equal to about or exactly 10 μm. The method 650 may further include removing 620 one or more portions of the metal film 614 to form a conductive network 602 having a plurality of openings (or spaces, or pores) 608. The removing 620 may include cutting, notching, stamping, or etching processes.

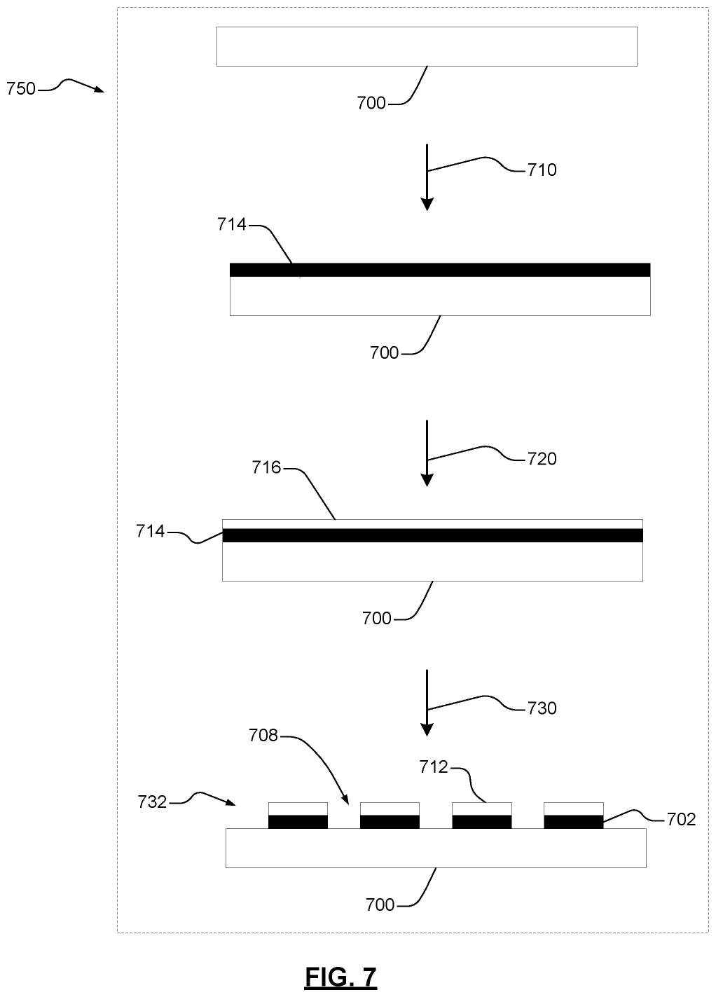

FIG. 7 illustrates an example method 750 for forming a patterned current collector 732 having one or more insulating layers 712, like the patterned current collector 532 illustrated in FIG. 5. The method 750 may include contacting 710 one or more surfaces of a non-conductive substrate 700 with a metal film 714. The contacting 710 may include disposing the metal film 714 on the one or more surfaces of the non-conductive substrate using, for example only, physical vapor deposition (PVD) processes, chemical vapor deposition (CVD) processes, sputtering processes, thermal evaporation processes, inkjet/aerosol jet printing, and the like. The method 700 further includes contacting 720 one or more exposed surfaces of the metal film 714 with an insulating material 716. The contacting 720 may include disposing the insulating material 716 on the one or more surfaces of the metal film 714 using, for example only, spin coating, blade casting, inkjet/aerosol jet printing, physical vapor deposition (PVD), chemical vapor deposition (CVD), atomic layer deposition (ALD), and the like. The method 700 may further include removing 730 one or more portions of the metal film 714 and insulating material 716 to form a conductive network 702 having a plurality of openings (or spaces, or pores) 708 and an insulating layer 712 disposed on or adjacent to the conductive network. The removing 730 may include cutting, notching, stamping, or etching processes.

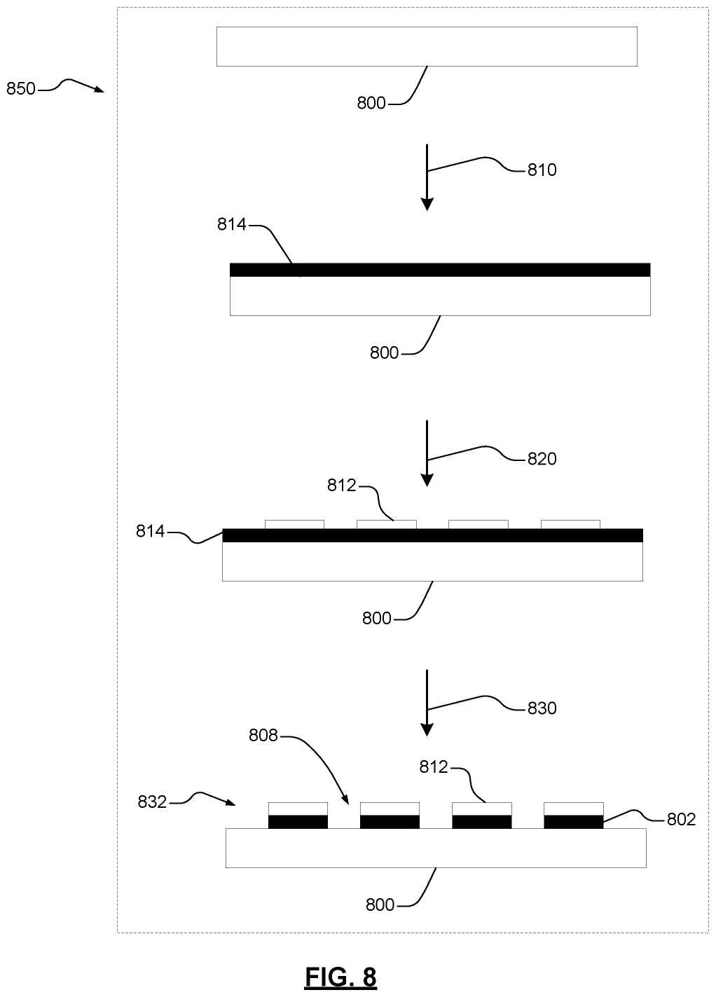

FIG. 8 illustrates an example method 850 for forming a patterned current collector 832 having one or more insulating layers 812, like the patterned current collector 532 illustrated in FIG. 5. The method 850 may include contacting 810 one or more surfaces of a non-conductive substrate 800 with a metal film 814. The contacting 810 may include disposing the metal film 814 on the one or more surfaces of the non-conductive substrate using, for example only, physical vapor deposition (PVD) processes, chemical vapor deposition (CVD) processes, sputtering processes, thermal evaporation processes, inkjet/aerosol jet printing, and the like. The method 800 further includes contacting 820 one or more exposed surfaces of the metal film 814 with an insulating layer 812, where the insulating layer 812 comprises a plurality of forming a predetermined pattern. The contacting 820 may include disposing the insulating material 812 on the one or more surfaces of the metal film 814 using, for example only, spin coating, blade casting, inkjet/aerosol jet printing, physical vapor deposition (PVD), chemical vapor deposition (CVD), atomic layer deposition (ALD), and the like. The method 800 further includes removing 830 one or more portions of the metal film 814 from around insulating material 816 to form a conductive network 802 having a plurality of openings (or spaces, or pores) 808. The removing 830 may include cutting, notching, stamping, or etching processes.

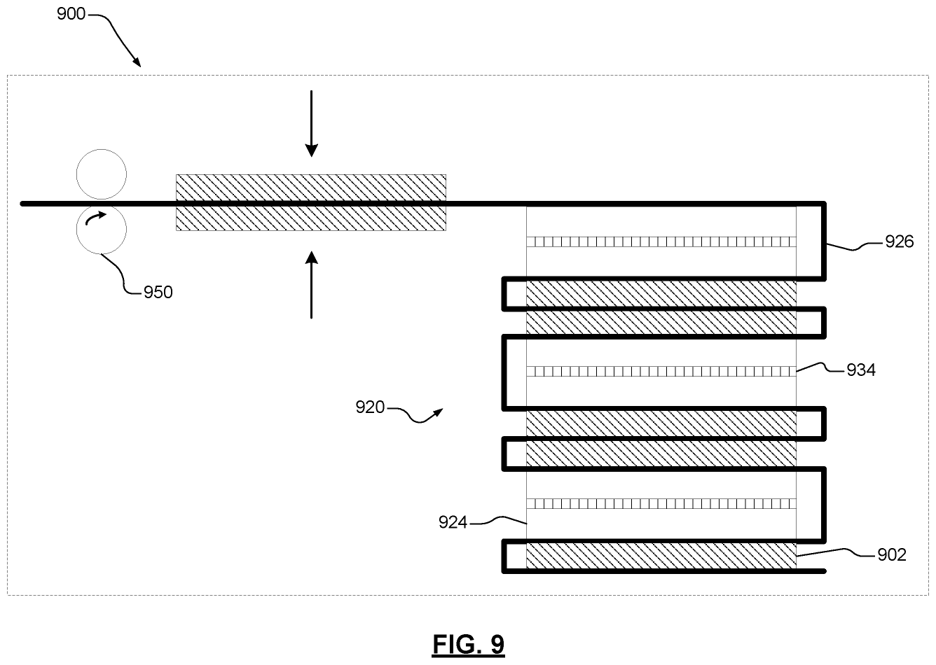

In various aspects, the present disclosure provides methods for forming batteries including patterned current collector. For example, as illustrated in FIG. 9, an anodeless battery including a patterned current collector in accordance with various aspects of the present disclosure may be prepared using a roll-to-roll process, where as a separator material 926 moves between a plurality of rollers (like the pair of rollers 950) different components of the battery (like a conductive network 902, a positive electroactive material layer 924, and/or a positive current collector 934) may be disposed on or adjacent to one or more surfaces of the separator material 926. The separator material 926 is then wound to form a battery stack 920. Although not illustrated, the skilled artisan will recognize that the conductive network 902 may be disposed on or adjacent to the separator material 926 using a direct deposition process, and in certain instances, a conductive adhesive layer may be first disposed on or adjacent to the separator material 926. In other variations, a positive electrode assembly including one or more electroactive material layers and a current collector may be prepared by passing the one or more electroactive material layers and the current collector through a first set or series of rollers, while a separator is simultaneously or concurrently passed through a second set or series of roller and a patterned current collector is formed by simultaneously or concurrently passing a non-conductive substrate and one or more conductive network layers through a third set or series or rollers. The first, second, and third rollers are configured such that the positive electrode, separator, and patterned current collector coverage and through a winding process forms batteries including patterned current collector.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A patterned current collector for use as a negative electrode current collector in an anodeless electrochemical cell that cycles lithium ions, the patterned current collector comprising:
a non-conductive substrate; and
a conductive network disposed on or adjacent to a surface of the non-conductive substrate, the conductive network having a porosity greater than or equal to about 20 vol. % to less than or equal to about 95 vol. %.

2. The patterned current collector of claim 1, wherein the surface of the non-conductive substrate defines a first surface area, and an outer perimeter of the conductive network defines a second surface area, wherein the second surface area covers greater than or equal to about or exactly 90% to less than or equal to exactly 100% of the first surface area.

3. The patterned current collector of claim 1, wherein the conductive network is a homogeneously dimensioned grid.

4. The patterned current collector of claim 1, wherein the conductive network comprises two or more overlapping layers.

5. The patterned current collector of claim 1, wherein the patterned current collector further comprises an insulating layer disposed over the conductive network.

6. The patterned current collector of claim 5, wherein the insulating layer has a thickness greater than or equal to about 0.5 μm to less than or equal to about 2 μm.

7. The patterned current collector of claim 1, wherein the non-conductive substrate has a thickness greater than or equal to about 1 μm to less than or equal to about 50 μm.

8. The patterned current collector of claim 1, wherein the conductive network has a thickness greater than or equal to about 1 μm to less than or equal to about 100 μm.

9. The patterned current collector of claim 1, wherein the conductive network is printed on the non-conductive substrate.

10. The patterned current collector of claim 1, wherein a conductive film is an etched conductive film disposed over the non-conductive substrate.

11. An anodeless electrochemical cell that cycles lithium ions, the anodeless electrochemical cell comprising:
a lithium-containing positive electroactive material layer disposed on a first current collector;
a second current collector, the second current collector being a patterned current collector comprising:
a non-conductive substrate; and
a conductive network disposed on or near a surface of the non-conductive substrate, the conductive network having a porosity greater than or equal to about 20 vol. % to less than or equal to about 95 vol. %.
a separator disposed between the positive electroactive material layer and the second current collector.

12. The electrochemical cell of claim 11, wherein the surface of the non-conductive substrate defines a first surface area, and an outer perimeter of the conductive network defines a second surface area, wherein the second surface area covers greater than or equal to about or exactly 90% to less than or equal to exactly 100% of the first surface area.

13. The electrochemical cell of claim 11, wherein the conductive network is a homogeneously dimensioned grid.

14. The electrochemical cell of claim 11, wherein the conductive network comprises two or more overlapping layers.

15. The electrochemical cell of claim 11, wherein the patterned current collector further comprises an insulating layer disposed on the conductive network.

16. The electrochemical cell of claim 15, wherein the insulating layer has a thickness greater than or equal to about 0.5 μm to less than or equal to about 2 μm.

17. The electrochemical cell of claim 11, wherein the non-conductive substrate has a thickness greater than or equal to about 1 μm to less than or equal to about 50 μm.

18. The electrochemical cell of claim 11, wherein the conductive network has a thickness greater than or equal to about 1 μm to less than or equal to about 100 μm.

19. The electrochemical cell of claim 11, wherein a composition of the non-conductive substrate is the same as a composition of the separator.

20. An anodeless electrochemical cell that cycles lithium ions, the anodeless electrochemical cell comprising:
a lithium-containing positive electroactive material layer having a thickness greater than or equal to about 1 μm to less than or equal to about 500 μm disposed on a first current collector;
a second current collector, the second current collector being a patterned current collector comprising:
a non-conductive substrate; and
a conductive network disposed on or near a surface of the non-conductive substrate, the surface of the non-conductive substrate defines a first surface area, a perimeter of the conductive network defines a second surface area, the second surface area covers greater than or equal to about or exactly 90% to less than or equal to exactly 100% of the first surface area, the conductive network includes a framework and a plurality of pores defined in the framework, such that the conductive network has a porosity greater than or equal to about 20 vol. % to less than or equal to about 95 vol. %; and
a separator having the same composition as the non-conductive substrate disposed between the positive electroactive material layer and the second patterned current collector, wherein during a charging event, the pores of the conductive network are configured to receive deposited lithium metal.
